(19) United States
(12) Patent Application Publication
(10) Pub. No.: US 2025/0356515 A1
(43) Pub. Date: Nov. 20, 2025

(54) INFORMATION-PROCESSING DEVICE FOR SUPPRESSING COMMUNICATION CAPACITY OF OCCLUSION, INFORMATION-PROCESSING SYSTEM, CONTROL METHOD OF INFORMATION-PROCESSING DEVICE, AND NON-TRANSITORY COMPUTER-READABLE MEDIUM

(71) Applicant: CANON KABUSHIKI KAISHA, Tokyo (JP)

(72) Inventor: TAKABUMI WATANABE, Kanagawa (JP)

(21) Appl. No.: 19/209,634

(22) Filed: May 15, 2025

(30) Foreign Application Priority Data
May 20, 2024 (JP) 2024-082195
Aug. 26, 2024 (JP) 2024-144262

(51) Int. Cl. G06T 7/50

(52) U.S. Cl. CPC G06T 7/50

(57) ABSTRACT

An information-processing device, that is a first device, includes one or more processors configured to perform a first acquisition process to acquire a first image, perform a first map-acquisition process to acquire a first depth-gradation-value map indicating depth-gradation-value information corresponding to the first image, perform a reduction process to generate a second depth-gradation-value map by reducing an amount of information of the first depth-gradation-value map based on meta information so as to represent a range of depth distance corresponding to the meta information, and perform a first transmission process to transmit the first image and the second depth-gradation-value map to a second device.

### BACKGROUND

### Technical Field

The present disclosure relates to an information-processing device, an information-processing system, a control method of an information-processing device, and a non-transitory computer-readable medium.

### Description of the Related Art

There is a technology that synthesizes virtual objects expressed by computer graphics (CG) into the real space and presents them to the user. This technology is called mixed reality (MR) and augmented reality (AR).

MR and AR are technologies that synthesize virtual objects into the real space. Therefore, it is recommended that a highly portable display device be used so that users can view various scenes in the real space. On the other hand, highly portable devices have limitations in computational resources and power. Therefore, a method (such as cloud rendering) has emerged in which a server terminal on the cloud processes the rendering of a 3D model, which is a heavy load, and transmits a virtual image that is the result of the processing to a client terminal on the display side. Considering the portability of the client terminal, it is preferable that the communication performed by the client terminal be wireless communication.

However, wireless communication has limitations in bandwidth and the like. In addition, in MR and AR, it is necessary to transmit and receive a depth-gradation-value map that represents the depth distance information of a virtual image. For example, when a real object exists in front of a virtual object, it is necessary to represent occlusion so that the real object occludes the virtual, making it invisible. To represent occlusion, the depth distance information of the real object and the depth distance information of the virtual object are required so that the depth distance of the real object and the depth distance of the virtual object can be compared. On the other hand, transmitting a depth-gradation-value map generally puts a large burden on bandwidth.

In Japanese Patent Application Publication No. 2021-140539, for an area where a real object exists in front of a virtual object and occlusion occurs (occlusion area), a client terminal generates a mask or a depth-gradation-value map of the real space and transmits it to a server terminal. The server terminal generates a CG image by excluding the drawing of the occlusion area and transmits the CG image to the client terminal. The client terminal then synthesizes the real space and the CG image. Thus, the transmission of the depth-gradation-value map from the server terminal to the client terminal is omitted.

In Japanese Patent Application Publication No. 2021-140539, it is necessary to transmit the depth-gradation-value map from the client terminal to the server terminal. For this reason, implementing occlusion between a real object and a virtual object in MR or AR imposes a significant burden on the communication bandwidth.

### SUMMARY

The present disclosure provides a technology for suppressing the communication capacity when implementing the occlusion of one object by another object in MR or AR.

The present disclosure in its one aspect provides an information-processing device that is a first device, the information-processing device including one or more processors configured to perform a first acquisition process to acquire a first image, perform a first map-acquisition process to acquire a first depth-gradation-value map indicating depth-gradation-value information corresponding to the first image, perform a reduction process to generate a second depth-gradation-value map by reducing an amount of information of the first depth-gradation-value map based on meta information so as to represent a range of depth distance corresponding to the meta information, and perform a first transmission process to transmit the first image and the second depth-gradation-value map to a second device.

The present disclosure in its one aspect provides a control method of an information-processing device that is a first device, the control method including acquiring a first image, acquiring a first depth-gradation-value map indicating depth-gradation-value information corresponding to the first image, generating a second depth-gradation-value map by reducing an amount of information of the first depth-gradation-value map based on meta information so as to represent a range of depth distance corresponding to the meta information, and transmitting the first image and the second depth-gradation-value map to a second device.

Further features of various embodiments of the present disclosure will become apparent from the following description of exemplary embodiments with reference to the attached drawings.

### BRIEF DESCRIPTION OF THE DRAWINGS

FIG. 1 is a configuration diagram of an information-processing system according to a first embodiment;

FIG. 2 is a flowchart of the processing of the information-processing system according to the first embodiment;

FIG. 3 is a flowchart of the process of generating depth-gradation-value meta information according to the first embodiment;

FIG. 4 is a diagram showing the relationship between the depth distance and the depth-gradation value according to the first embodiment;

FIG. 5 is a diagram showing the relationship between the depth distance and the depth-gradation value according to Modification 1;

FIG. 6 is a flowchart of the process of generating depth-gradation-value meta information according to Modification 1;

FIG. 7 is a diagram illustrating a plurality of real objects according to Modification 2;

FIG. 8 is a flowchart of the process of generating depth-gradation-value meta information according to Modification 2;

FIG. 9 is a configuration diagram of an information-processing system according to Modification 3;

FIG. 10 is a hardware configuration diagram of a first information-processing device according to the first embodiment;

FIGS. 11A and 11B are diagrams illustrating depth-gradation-value meta information according to the first embodiment;

FIGS. 12A and 12B are diagrams illustrating a simplified map according to Modification 2;

FIG. 13 is a flowchart of the process of generating depth-gradation-value meta information according to Modification 4;

FIG. 14 is a flowchart of the process of generating a simplified map according to Modification 4;

FIGS. 15A and 15B are diagrams illustrating the process of predicting the target range of depth-gradation-value meta information according to Modification 4; and

FIGS. 16A to 16D are diagrams illustrating the amount of information in a simplified map according to Modification 5.

### DESCRIPTION OF THE EMBODIMENTS

### First Embodiment

In the first embodiment, an example of a video see-through MR system capable of expressing reality and virtuality in a fusion manner will be described. In the first embodiment, both “high portability of the display device” and “high-load CG rendering in the entire system” can be achieved. For this purpose, a head-mounted display device and a server that performs CG rendering are connected by wireless communication. Hereinafter, the head-mounted display device will be referred to as an “HMD”.

Note that an AR system that uses an optical see-through display device to superimpose a virtual image on the real space has a configuration different from the “imaging unit and synthesis unit” described below. However, the technology described in the first embodiment (a method for reducing the amount of information in the depth-gradation-value map) can also be applied to AR. In addition, the display device may be a handheld device (such as a smartphone or tablet PC) instead of an HMD.

In order to seamlessly synthesize a virtual object into the real space, it is important to express occlusion. In order to express occlusion, depth-distance information of a real object and depth-distance information of a virtual object are generally required. When performing CG rendering, a depth-gradation-value map is used to determine whether a 3D model is in front or behind. This depth-gradation-value map is generally expressed in 16 bits to 32 bits. Therefore, if the depth-gradation-value map at the time of rendering generation is sent to the client terminal as is, the communication bandwidth is significantly burdened.

On the other hand, if only occlusion is to be implemented, only an amount of information smaller than that required for CG rendering may be required. For example, if only occlusion between a hand (or a real object held in the hand) and a virtual object is to be implemented, occlusion can be implemented with depth-gradation-value information within a range of about 1 meter from the viewpoint (HMD). This allows the number of bits of depth-gradation-value information to be reduced.

Therefore, an information-processing system (MR system) that reduces the amount of information of depth-gradation-value information used for transmission and reception will be described below. In the following, the distance in the optical axis direction from the viewpoint (=reference position of imaging) in three-dimensional space is called the “depth distance”. The value obtained by converting the “depth distance” into a pixel value on the depth-gradation-value map (pixel value of the distance image) is called the “depth-gradation value”.

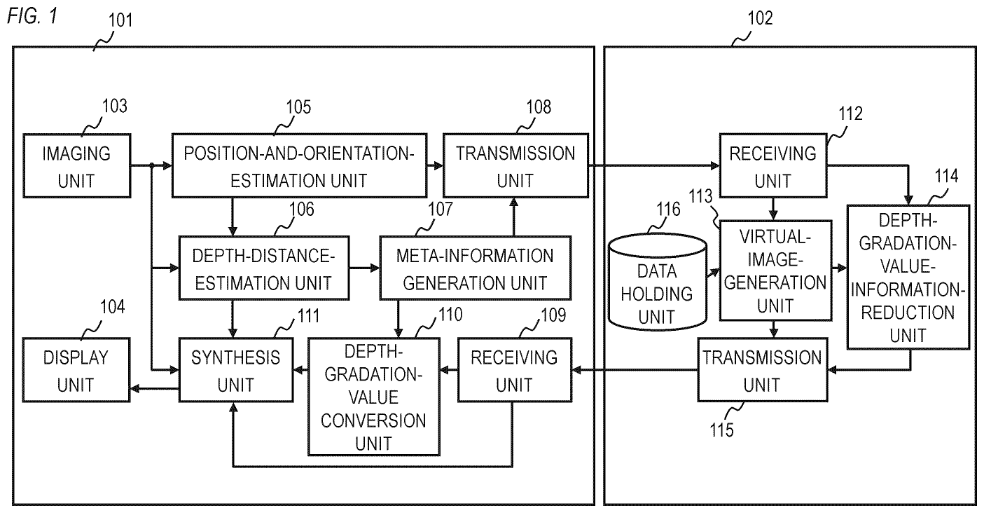

FIG. 1 shows an overall block diagram of an information-processing system according to the first embodiment. The information-processing system has a first information-processing device 101 and a second information-processing device 102. The first information-processing device 101 is a client terminal for presenting an MR space to a user. In the first embodiment, the first information-processing device 101 is an HMD. The second information-processing device 102 is a rendering server (server terminal) for generating a virtual image in the MR space.

### First Information-Processing Device

The first information-processing device 101 has an imaging unit 103, a display unit 104, a position-and-orientation-estimation unit 105, a depth-distance-estimation unit 106, a meta-information generation unit 107, a transmission unit 108, a receiving unit 109, a depth-gradation-value conversion unit 110, and a synthesis unit 111. The components of the first information-processing device 101 may be implemented in the same housing of the HMD. Also, the display unit 104 and the imaging unit 103 may be configured in the HMD, and the other blocks may be implemented in a portable housing, such as a smartphone.

The imaging unit 103 has a camera that acquires a color image (captured image) of the real space. The imaging unit 103 has a camera for acquiring an image used for position-and-orientation estimation and real-depth-distance estimation. Note that the imaging unit 103 may have a separate camera for each purpose, or may achieve two or more purposes with one camera. In addition, each of the cameras for these purposes may have left and right stereo cameras. In the first embodiment, the imaging unit 103 is fixed to the HMD and moves in accordance with the movement of the HMD. In the first embodiment, the imaging unit 103 has a stereo camera to show different images to each of the left and right eyes of the user.

The display unit 104 is a device for displaying images. In the first embodiment, the display unit 104 uses a display mounted on the HMD worn by the user. In the HMD, a lens for eyepiece display is required for observation. In addition, in a handheld device, such as a smartphone, the display unit 104 may be a main display. In a handheld device, a lens for eyepiece display is not required.

The position-and-orientation-estimation unit 105 estimates the position and orientation of the imaging unit 103 (position and orientation of the viewpoint). The position-and-orientation-estimation unit 105 estimates the position and orientation of the imaging unit 103, for example, by using Visual SLAM or Visual Odometry that uses the images acquired by the imaging unit 103. At this time, the position and orientation estimation unit 105 may estimate the position and orientation of the imaging unit 103 by using an inertial measurement unit (IMU) in combination.

The position-and-orientation-estimation unit 105 may estimate the position and orientation by other methods that do not use the images captured by the imaging unit 103. For example, the position-and-orientation-estimation unit 105 may use an outside-in method, such as motion capture. In the first embodiment, the virtual-image-generation unit 113 performs stereo rendering based on the estimated position and orientation. However, if the relative position and orientation between the stereo cameras is known in advance as a parameter, it is sufficient to estimate the position and orientation of one of the cameras.

The depth-distance-estimation unit 106 estimates a depth-gradation-value map indicating depth-distance information corresponding to the captured image (real image). Specifically, the depth-distance-estimation unit 106 estimates the depth-gradation value of an object existing in the real space spreading in front of the HMD (user) to obtain a depth-gradation-value map of the real object (hereinafter referred to as a “real map”). The depth-gradation-value map has the same resolution as the captured image, and is an image in which each pixel indicates a depth-gradation value.

The meta-information-generation unit 107 generates depth-gradation-value meta information based on the real map obtained by the depth-distance-estimation unit 106. The depth-gradation-value meta information is information necessary for the depth-gradation-value-information-reduction unit 114 to reduce the amount of information of the depth-gradation-value map of the virtual object. Hereinafter, the depth-gradation-value map of the virtual object may be referred to as a “virtual map”.

The transmission unit 108 transmits information on the position and orientation (position-and-orientation information) estimated by the position-and-orientation-estimation unit 105 and the depth-gradation-value meta information to the second information-processing device 102.

The receiving unit 109 receives the virtual image and the virtual map with the amount of information reduced from the second information-processing device 102. In the following, the virtual map after the amount of information has been reduced by the second information-processing device 102 may be referred to as a “simplified map”.

The depth-gradation-value-conversion unit 110 converts at least one of the two depth-gradation values using depth-gradation-value meta information so that the depth-gradation value indicated by the real map can be compared with the depth-gradation value indicated by the simplified map. This is because the real map and the simplified map are expressed in different formats.

The synthesis unit 111 synthesizes the image of the real space and the virtual image based on the depth-gradation value (depth-gradation value of the real object and depth-gradation value corresponding to the virtual image) after processing by the depth-gradation-value-conversion unit 110. In this way, the synthesis unit 111 generates a mixed-reality image (synthetic image) in which the virtual object appears to exist consistently in the real space.

The configuration of the second information-processing device 102 will be described. The second information-processing device 102 has a receiving unit 112, a virtual-image-generation unit 113, a depth-gradation-value-information-reduction unit 114, a transmission unit 115, and a data-holding unit 116.

The receiving unit 112 receives position-and-orientation information and depth-gradation-value meta information from the first information-processing device 101.

The data-holding unit 116 has a hard disk or a solid state drive. The data-holding unit 116 stores data (shape data, material data, and animation data) for generating a virtual image. The stored data is loaded into a memory used by the CPU when generating a virtual image or a memory on the GPU.

The virtual-image-generation unit 113 performs rendering (generation) of a virtual image based on the position-and-orientation information, the parameters of the virtual camera, and the CG model data. In the first embodiment, the virtual-image-generation unit 113 generates a virtual image for the right eye and a virtual image for the left eye based on the relative position and orientation between the stereo cameras that are defined in advance to realize stereoscopic vision. In addition, when generating a virtual image, the virtual-image-generation unit 113 generates a virtual map for the right eye and a virtual map for the left eye. Therefore, the virtual image generation unit 113 is also a map-generation unit (map-acquisition unit) that generates a virtual map indicating depth-gradation-value information corresponding to the virtual image. Note that, in the following, the “virtual image” and the “virtual map” will be described without distinguishing between those for the right eye and those for the left eye. The virtual map is passed to the depth-gradation-value-information-reduction unit 114.

The depth-gradation-value-information-reduction unit 114 reduces the amount of information of the virtual map acquired from the virtual-image-generation unit 113 based on the depth-gradation-value meta information to generate a simplified map. A specific method for generating the simplified map will be described later.

The transmission unit 115 transmits the stereo virtual image (color information) generated by the virtual-image-generation unit 113 and the simplified map generated by the depth-gradation-value-information-reduction unit 114 to the first information-processing device 101.

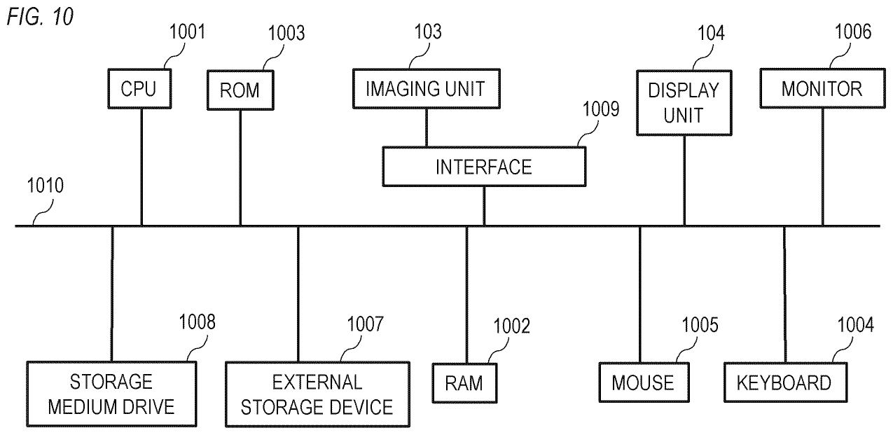

FIG. 10 is a block diagram showing an example of a hardware configuration of a computer applicable to the first information-processing device 101. The computer has a CPU 1001, a RAM 1002, a ROM 1003, a keyboard 1004, a mouse 1005, and a monitor 1006 in addition to an imaging unit 103 and a display unit 104. The computer has an external storage device 1007, a storage medium drive 1008, and an interface 1009. The second information-processing device 102 may also have a hardware configuration similar to that of the first information-processing device 101.

The CPU 1001 is a control unit that controls the entire computer using programs and data stored in the RAM 1002 or the ROM 1003. The CPU 1001 executes each process performed by the first information-processing device 101.

The RAM 1002 has an area for temporarily storing programs and data loaded from the external storage device 1007 or the storage medium drive 1008. Furthermore, the RAM 1002 has an area for temporarily storing data received from the outside via the interface 1009. The data received from the outside may be, for example, a captured image. The RAM 1002 also has a work area used by the CPU 1001 when it executes each process. That is, the RAM 1002 can provide various areas as appropriate.

The ROM 1003 stores the computer's setting data and boot program.

The keyboard 1004 and the mouse 1005 are input devices (operation members) that accept user operations. The computer user can input various instructions to the CPU 1001 by operating at least one of the keyboard 1004 and the mouse 1005.

The monitor 1006 is a display device different from the display unit 104, and has a CRT or liquid crystal screen. The monitor 1006 can display the results of the processes executed by the CPU 1001 as images or characters.

The external storage device 1007 is a large-capacity information-storage device, such as a hard-disk-drive device. The external storage device 1007 stores programs (such as an operating system (OS)) and data for causing the CPU 1001 to execute the above-mentioned processes described as being performed by each information-processing device. These programs include programs executed by each component of each information-processing device in the information-processing system. These pieces of data also include data of the virtual space and what has been described above as known information.

The programs and data stored in the external storage device 1007 are loaded into the RAM 1002 as appropriate under the control of the CPU 1001. The CPU 1001 executes the processes described above as being performed by each information-processing device by executing the processes using the loaded programs and data.

The storage medium drive 1008 reads out the programs and data recorded in a storage medium (such as a CD-ROM or a DVD-ROM). The storage medium drive 1008 also writes the programs and data to the storage medium. Note that some or all of the programs and data described as being stored in the external storage device 1007 may be recorded in this storage medium. The programs and data read by the storage medium drive 1008 from the storage medium are output to the external storage device 1007 or the RAM 1002.

The interface 1009 is an interface for connecting to the imaging unit 103. The interface 1009 has an analog video port or a digital input/output port (such as IEEE1394). The interface 1009 may also have an Ethernet Port® or the like for outputting to the display unit 104. The data input via the interface 1009 is output to the RAM 1002 or the external storage device 1007. When a sensor system is used to acquire position and orientation information, the sensor system is connected to the interface 1009.

The bus 1010 is a bus connecting the above-mentioned units.

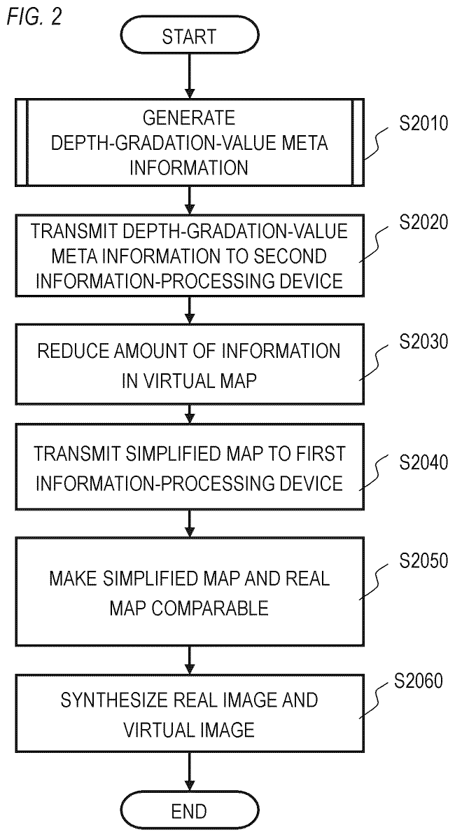

The processing of the first information-processing device 101 and the second information-processing device 102 according to the first embodiment will be described with reference to the flowchart of FIG. 2.

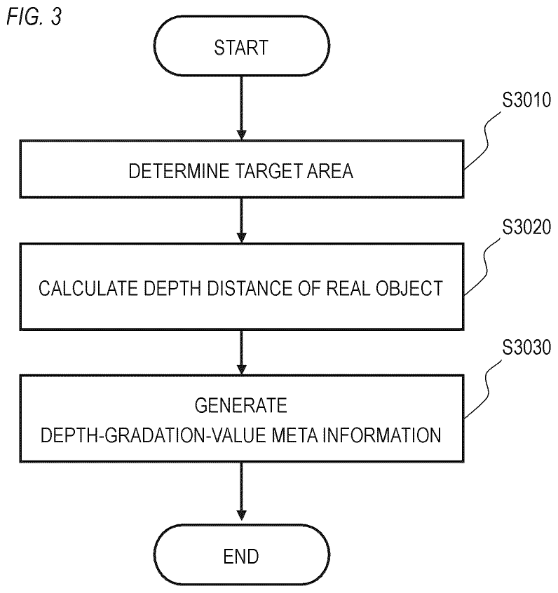

In step S2010, depth-gradation-value meta information for reducing the amount of information in the virtual map is generated. Details of the processing of step S2010 will be described with reference to the flowchart of FIG. 3.

In step S3010, the depth-distance-estimation unit 106 determines the area of the real object to be occluded (hereinafter referred to as the “target area”) on the basis of the image (real image) acquired by the imaging unit 103. The real object expressing the occlusion with the virtual object can be specified (limited) depending on the purpose of use. For example, in verifying the workability of product assembly in the manufacturing industry, the parts to be assembled are expressed as virtual objects, and a user wearing an HMD interferes with the virtual object with his/her real body. In this case, it is sufficient to express the occlusion between the user's body and the virtual object. Therefore, the user's body area is determined as the target area. Semantic segmentation by machine learning may be used to determine the body area. In addition, a method of “estimating skeletal information and defining an area based on the estimation result” may be used to determine the body area. In addition, a specified color range may be determined as the body area. The method of determining the target area is not limited to the above.

In step S3020, the depth-distance-estimation unit 106 calculates the depth distance of the target area (area of the real object) determined in step S3010. The depth distance may be calculated from a real image (stereo image) obtained by the imaging unit 103 using semi-global matching or deep learning, or may be calculated using a distance sensor or the like. The IR camera stereo provided in the imaging unit 103 may capture a pattern projected onto a real object by an IR dot projector, and the depth-distance-estimation unit 106 may calculate the depth distance by stereo matching of the captured image of the pattern.

If noise occurs in the estimation of the depth distance and an extreme value is generated, the depth-distance-estimation unit 106 may discard the value or perform a smoothing process.

The order of the processes in steps S3010 and S3020 may be reversed. For this reason, the depth-distance-estimation unit 106 may determine the target area based on the shape or depth-gradation-value information of the three-dimensionally reconstructed real object.

The depth-distance-estimation unit 106 generates a depth-gradation-value map by converting the depth distance of each pixel calculated in this way into a depth-gradation value. Conversion between depth distance and depth-gradation value may be performed using a conversion described in step S2030 (the same conversion as that used for generating a depth-gradation-value map after removing the amount of information using depth-gradation-value meta information) or may use any conversion formula between near-far value, depth distance, and depth-gradation value.

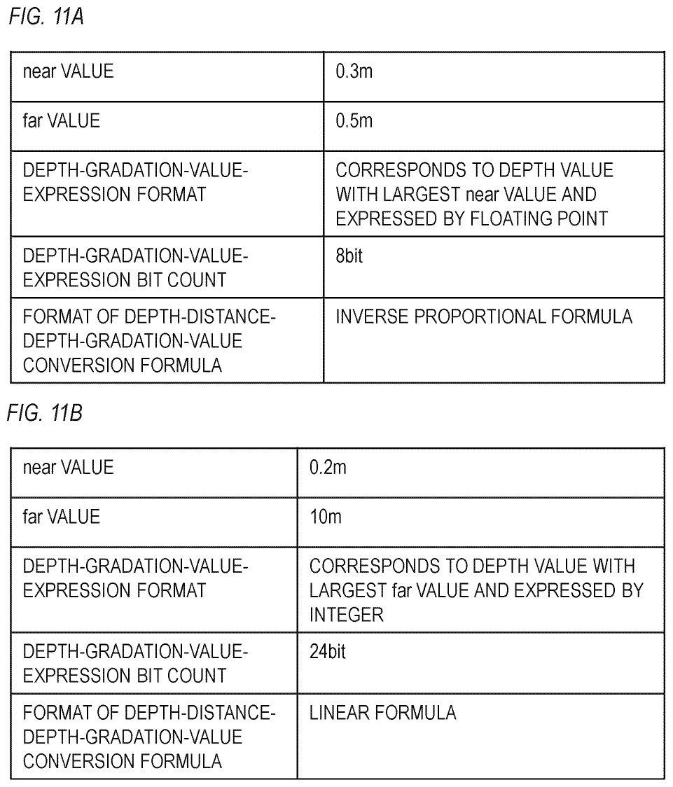

In step S3030, the meta-information-generation unit 107 calculates the near value and far value of the real object. Then, the meta-information-generation unit 107 generates information that summarizes “near value, far value, depth-gradation-value-expression format, and depth-gradation-value-expression bit count” as shown in FIG. 11A and FIG. 11B as depth-gradation-value meta information. The meta-information-generation unit 107 may include the format of the depth-distance-depth-gradation-value conversion formula (information of the formula for converting depth distance to depth-gradation value) in the depth-gradation-value meta information as necessary.

The near value is the value of the closest depth distance in the target area (real object) calculated in steps S3010 and S3020 (the minimum value of the depth distance). The far value is the value of the deepest depth distance in the target area (the maximum value of the depth distance). In this case, if the value of the closest depth distance in the target area is smaller than the first threshold, the meta information generation unit 107 may determine the first threshold as the near value. If the value of the deepest depth distance in the target area is larger than the second threshold, the meta-information-generation unit 107 may determine the second threshold as the far value.

The depth-gradation-value-expression format indicates whether the depth-gradation value is expressed by an integer or a floating point in the simplified map. In addition, the depth-gradation-value-expression format indicates whether the near value is associated with the largest depth-gradation value in the simplified map, or whether the far value is associated with the largest depth-gradation value. A predetermined format may be set as the depth-gradation-value-expression format, or a format suited to the characteristics of a renderer that generates the virtual image may be determined.

The depth-gradation-value-expression bit count indicates how many bits are used to express the depth-gradation value of each pixel of the simplified map. A predetermined value may be used for the depth-gradation-value-expression bit count. The depth-gradation-value expression bit count may be a value corresponding to the state of communication detected by the transmission unit 108 or the transmission unit 115.

The format of the depth-distance-depth-gradation-value-conversion formula is the format of the relational formula between the depth distance and the depth-gradation value of the virtual image in the simplified map. The format of the depth-distance-depth-gradation-value-conversion formula indicates whether it is an inverse-proportional formula or a linear formula. Specific conversion related to the inverse-proportional formula will be described later with reference to step S2030.

In step S2020, the transmission unit 108 transmits the depth-gradation-value meta information to the second information-processing device 102.

In step S2030, the depth-gradation-value-information-reduction unit 114 reconstructs the virtual map generated by the virtual-image-generation unit 113 based on the depth-gradation-value meta information. In this way, the depth-gradation-value-information-reduction unit 114 reduces the amount of information in the virtual map to generate a simplified map.

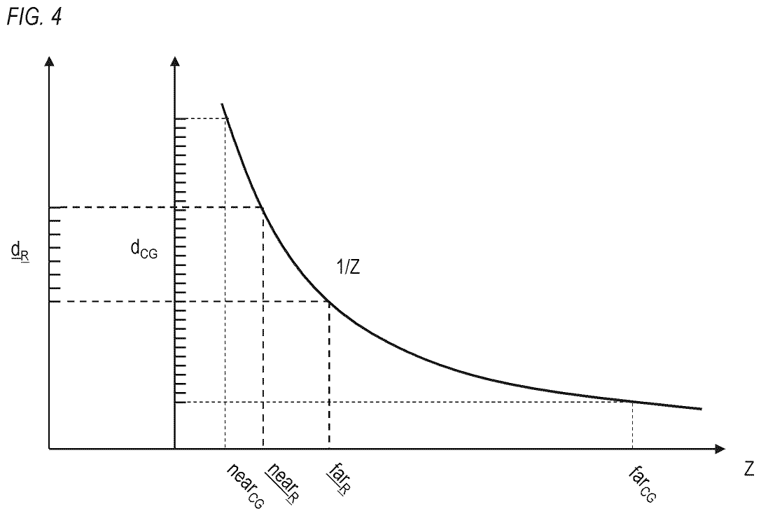

FIG. 4 shows the relationship between the depth-gradation value d_{CG} of the virtual map (depth-gradation-value map before the reduction of the amount of information) and the depth-gradation value d_{R} of the simplified map (depth-gradation-value map after the reduction of the amount of information) with respect to the depth distance Z from the viewpoint (reference position) for each pixel of the depth-gradation-value map. The scales of the depth-gradation values d_{CG} and d_{R} on the vertical axis indicate the depth-gradation values that can be expressed in each depth-gradation-value map. Note that in FIG. 4, the scales on the vertical axis are spaced at equal intervals. However, when the depth-gradation-value-expression format is a floating-point expression format, the exponent part and the mantissa part each have a fixed length, and the change width of one bit at the end of the mantissa part depends on the exponent part, so the intervals of the scale on the vertical axis are not equal.

Generally, in CG rendering, the correspondence with the calculation of perspective transformation of a three-dimensional space into a two-dimensional image is taken into consideration. Therefore, regarding the relationship between the depth distance Z and the depth-gradation value, the depth-gradation value corresponds linearly to the inverse number (1/Z) of the depth distance Z. Note that which of the near and far depth values corresponds to the maximum depth-gradation value that can be represented in the depth-gradation-value map depends on factors such as the renderer, and is not particularly limited.

In addition, in FIG. 4, for simplicity, the relationship curve between the depth distance Z and the depth-gradation value is expressed by the same curve before and after the reduction of the amount of information. However, the depth-gradation-value-expression format may be different before and after the reduction of the amount of information, or the parameters of the linear correspondence with the inverse of the depth distance Z (1/Z) may be different. The relation curve between the depth distance Z and the depth-gradation value may be expressed by a function other than 1/Z.

In the first embodiment, the maximum or minimum value of the depth-gradation value d_{R} that can be expressed by the depth-gradation-value-expression format and the depth-gradation-value-expression bit count indicated by the depth-gradation-value meta information is assigned to the near value (near_{R}) and far value (far_{R}) indicated by the depth-gradation-value meta information. In addition, the range corresponding to the near value (near_{R}) and the far value (far_{R}) of the depth-gradation-value meta information is determined from the range of the depth-gradation value d_{CG} that expresses the range between the near value (near_{CG}) and the far value (far_{CG}) of the object in the virtual image. The range can then be converted to be expressed by the expression format of the depth-gradation value d_{R}.

For example, for the virtual map, the near value (near_{CG}) is 0.01 m and the far value (far_{CG}) is 100 m. Let d be a 24-bit unsigned integer value. Let near be 0.3 m and far_{R} be 0.5 m for the simplified map. Let us consider a case where the depth-gradation-value-expression bit count is an 8-bit unsigned integer and the depth distance and the depth-gradation value are inversely proportional to each other.

First, let us assume that the relational expression between the depth distance Z and the depth-gradation value d_{CG} is d_{CG}=a1/Z+b1 before the reduction of the amount of information, and that the relational expression between the depth distance Z and the depth-gradation value d_{R} is d_{R}=a2/Z+b2 after the reduction of the amount of information. The coefficients a1, b1, a2, and b2 can be calculated for each of the virtual map and the simplified map based on the correspondence between the “minimum value 0 and maximum value of the depth-gradation value” and the “near value and far value”. Specifically, a1=−167788.9 and b1=16778892.9 hold before the amount of information is reduced, and a2=−191.25 and b2=637.5 hold after the amount of information is reduced.

Using this relational expression, the depth distance can be calculated from the depth-gradation value of each pixel of the virtual map, and the depth distance can be converted into the depth-gradation value after the reduction of the amount of information by substituting the depth distance into the “relational expression between the depth-gradation value after the reduction of the amount of information and the depth distance”. At this time, the amount of information is reduced by converting the depth-gradation value into an integer or by truncating a value outside of the range (0 to 255) to 255 or 0.

The relational expression between the depth distance Z and the depth-gradation value d is not limited to the above-mentioned expression, and may be expressed, for example, as a linear expression using Z. In the above, the minimum value of the depth-gradation value is associated with the near value and the maximum value is associated with the far value, but the association may be reversed. The relational expression between the depth distance Z and the depth-gradation value d needs to be shared between the depth-gradation-value-conversion unit 110 and the depth-gradation-value-information-reduction unit 114. For this reason, it is preferable that the depth-gradation-value-conversion unit 110 and the depth-gradation-value-information-reduction unit 114 each have information on a predetermined equation. If this is not the case, information on the type of the relational expression between the depth distance Z and the depth-gradation value d may also be included in the depth-gradation-value meta information.

In step S2040, the transmission unit 115 transmits the simplified map together with the virtual image to the first information-processing device 101. At this time, the transmission unit 115 may acquire information on the communication status (such as delay, loss rate, and amount of information waiting for communication) via hardware that realizes communication or an API of a communication library so that the degree of reduction of the amount of information can be adjusted according to the communication status. Then, the transmission unit 115 may transmit the acquired information to the first information-processing device 101 so that the information can be referenced when the meta-information-generation unit 107 generates depth-gradation-value meta information. In other words, the meta-information-generation unit 107 may control (change) information on the depth-gradation-value-expression format or information on the depth-gradation-value-expression bit count according to the communication status between the first information-processing device 101 and the second information-processing device 102.

In step S2050, the depth-gradation-value-conversion unit 110 converts the depth-gradation value of the simplified map to a “value comparable to the depth-gradation value of the real map” based on the depth-gradation-value meta information. However, if the “correspondence between the depth-gradation value and the depth distance in the simplified map” is the same as the “correspondence between the depth-gradation value and the depth distance in the real map”, the depth-gradation-value-conversion unit 110 does not convert the depth-gradation value.

If the correspondence between the depth-gradation value and the depth distance differs between the real map and the simplified map, the depth-gradation-value-conversion unit 110 performs conversion so that the correspondence between the depth-gradation value and the depth distance in the two depth-gradation-value maps matches. Here, the correspondence between the depth-gradation value and the depth distance in the real map is defined in step S3020. In the simplified map, the correspondence between the depth-gradation value and the depth distance is also defined on the basis of the depth-gradation-value meta information in step S2030. Therefore, the depth-gradation-value-conversion unit 110 can convert the correspondence between the two depth-gradation-value maps via the depth distance. It is not limited whether the conversion is performed to match the correspondence of the real map or to match that of the simplified map.

In step S2060, the synthesis unit 111 compares the depth-gradation values of the real map and the simplified map, and synthesizes the real image and the virtual image so that the foreground-background relationship is expressed consistently. Specifically, the synthesis unit 111 implements occlusion by not drawing the virtual object in the area where the real object is in front of the virtual object. The real image used in step S2060 may be the same image as the real image used to generate the depth-gradation-value meta information, or may be an image acquired (captured) at a later time than the real image used to generate the depth-gradation-value meta information. In addition, the real map used in step S2060 may be estimated on the basis of any image.

According to the first embodiment, the amount of information transmitted from the second information-processing device 102 to the first information-processing device 101 can be reduced by reducing the amount of information of the virtual map based on the depth-gradation-value meta information so as to express only the range of depth distance corresponding to the depth-gradation-value meta information. Therefore, it is possible to suppress a shortage of communication bandwidth between the first information-processing device 101 and the second information-processing device 102.

### Modification 1

In the first embodiment, it is assumed that the occlusion target is a real object (such as the body of a user wearing an HMD) with a continuous depth distance. On the other hand, there are also cases where not only the user's body or held object but also walls or furniture present in the space are the occlusion target. In this case, when using the method described in the first embodiment, the near value and the far value can be calculated by estimating the depth-gradation value in the entire visual field. However, when there is a certain depth distance between the “user's body or held object” and the “wall or furniture and the like”, the depth-gradation-value information indicating the depth-gradation value therebetween is often useless in performing occlusion. In Modification 1, therefore, a method for suppressing such waste will be described. Note that the block diagram of the entire information-processing system according to Modification 1 is shown in FIG. 1, and the overall processing flowchart is shown in FIG. 2, so that the description of them will be omitted.

In Modification 1, when there is a certain depth distance between the user's body or held object (hereinafter referred to as the “foreground”) and the wall or furniture and the like (hereinafter referred to as the “background”), the meta-information-generation unit 107 calculates the near value and the far value of each of the foreground and the background. Then, the meta-information-generation unit 107 does not express the range where no object exists between the foreground and the background as a depth-gradation value.

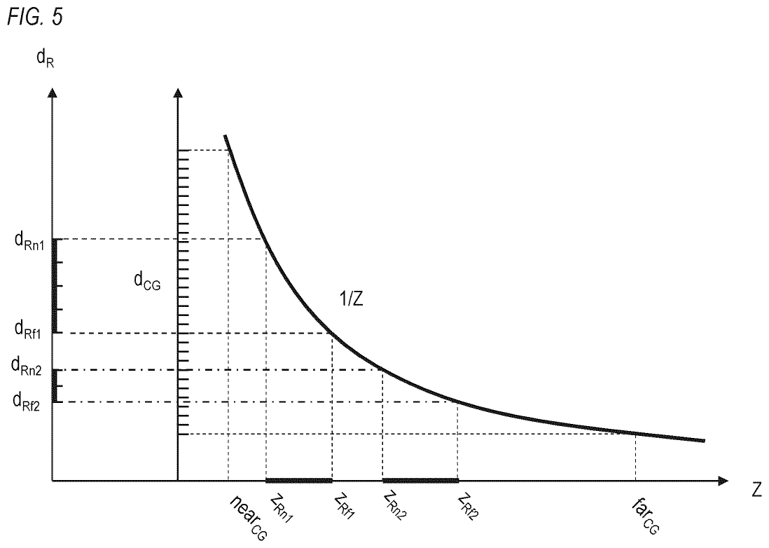

As shown in FIG. 5, the near value of the foreground is “Z_{Rn1}”, and the far value of the foreground is “Z_{Rf1}”. In addition, the near value of the background is “Z_{Rn2}” and the far value of the background is “Z_{Rf2}”. In this case, after reducing the amount of information in the depth-gradation-value map, the depth-gradation value corresponding to Z_{Rn1} is “d_{Rn1}”, the depth-gradation value corresponding to Z_{Rf1} is “d_{Rf1}”, the depth-gradation value corresponding to Z_{Rn2} is “d_{Rn2}”, and the depth-gradation value corresponding to Z_{Rf2} is “d_{Rf2}”. When the depth-gradation values are expressed using the depth-gradation-value-expression format and depth-gradation-value-expression bit count indicated by the depth-gradation-value meta information, by placing the depth-gradation values d_{Rf1} and d_{Rn2} adjacent to each other, it is possible to omit the depth-gradation-value information between the depth distance Z_{Rf1} and the depth distance Z_{Rn2}, where no real object exists. Such information on the depth distances Z_{Rn1}, Z_{Rf1}, Z_{Rn2}, Z_{Rf2} and the corresponding depth-gradation values d_{Rn1}, d_{Rf1}, d_{Rn2}, d_{Rf2} is expressed in a table.

Note that in this case, the “relationship between Z_{Rn1}−Z_{Rf1} and d_{Rn1}−d_{Rf1}” and the “relationship between Z_{Rn2}−Z_{Rf2} and d_{Rn2}−d_{Rf2}” do not need to be expressed by the same formula. For example, the ratio of d_{Rn1}−d_{Rf1} in the foreground related to the body and virtual objects to the range of values that can be expressed by the entire d_{R} may be increased to increase the resolution. The above-mentioned table is shared between the first information-processing device 101 and the second information-processing device 102 as depth-gradation-value meta information, thereby reducing the depth-gradation-value information and ensuring consistency in the conversion.

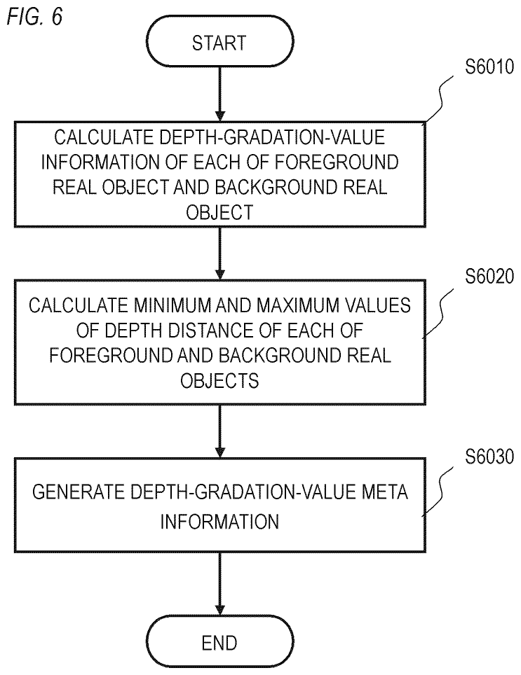

Next, a specific method for separating the foreground and background and calculating the depth-gradation-value meta information described above will be described. This process corresponds to step S2010 shown in FIG. 2. Details of step S2010 will be described with reference to the flowchart in FIG. 6.

In step S6010, the depth-distance-estimation unit 106 defines (separates) the foreground real object and the background real object, and calculates the depth-gradation-value maps of the foreground real object and the background real object. The foreground real object can be determined by the method described in the first embodiment.

Note that the foreground real object and the background real object can be determined on the basis of the assumption that “the foreground real object is often a dynamic object, and the background real object is often a static object”. The depth-distance-estimation unit 106 reprojects the depth-gradation-value map of the previous frame from the viewpoint of the current frame, and calculates the difference between the reprojected depth-gradation-value map and the depth-gradation-value map of the current frame. The depth-distance-estimation unit 106 may determine the area where the difference occurs and is within a predetermined range of depth-gradation values as the area of a foreground real object (hereinafter referred to as a “foreground target area”). The depth-distance-estimation unit 106 may determine the area other than the foreground target area as the area of a background real object (hereinafter referred to as a “background target area”).

When calculating the depth-gradation-value map of the background target area, the depth-distance-estimation unit 106 may reconstruct three-dimensional information from multi-viewpoint information accumulated between frames for non-foreground areas using a Structure from Motion (SfM) method or a machine learning method. When three-dimensional reconstruction is required, any method described in the first embodiment can be used. Furthermore, if noise occurs in the estimation of the depth-gradation-value information and extremely different depth-gradation values are generated, the depth-distance-estimation unit 106 removes the values or performs a smoothing process.

In step S6020, the depth-distance-estimation unit 106 calculates the minimum depth distance Z_{Rn1} and the maximum depth distance Z_{Rf1} in the foreground object area. The depth-distance-estimation unit 106 calculates the minimum depth distance Z_{Rn2} and the maximum depth distance Z_{Rf2} in the background object area.

In step S6030, the meta-information-generation unit 107 generates depth-gradation-value meta information. The depth-gradation-value meta information includes a depth-gradation-value-expression format and a depth-gradation-value-expression bit count. The depth-gradation-value meta information includes a table showing the depth distances Z_{Rn1}, Z_{Rn2}, Z_{Rf1}, and Z_{Rf2} and the depth-gradation values d_{Rn1}, d_{Rn2}, d_{Rf1}, and d_{Rf2} corresponding to those depth distances. The depth-gradation-value meta information includes information on the type of “formula for converting depth distances to depth-gradation values” for each of the foreground and background as necessary. Note that if the depth distance Z_{Rn2} of the nearest point indicates a closer depth distance than the depth distance Z_{Rf1} of the farthest point, the foreground and background may be integrated into one depth-gradation-value area.

By generating the depth-gradation-value meta information in this way, the depth-gradation-value-information-reduction unit 114 can reduce the amount of information of the virtual map so as to represent only the “range between the depth distance Z_{Rn1} and the depth distance Z_{Rn2}, and the range between the depth distance Z_{Rf1} and the depth distance Z_{Rf2}”. Thus, it is possible to generate a simplified map with a smaller amount of information, and to further suppress the burden on communication bandwidth.

In Modification 1, the depth-gradation-value information is separated into two stages, foreground and background, in the depth direction, but it may be separated into three or more stages. For example, the depth-gradation-value map may be clustered by its depth distance value, and a table may be generated in which the “minimum and maximum depth-distance values” and the “corresponding depth-gradation values” are associated for each class, and this may be used as the depth-gradation-value meta information. Other methods of division may include segmentation of the color image or the depth-gradation-value map, and a similar process may be performed for each segment.

### Modification 2

In the first embodiment and Modification 1, the information-processing system focuses on the depth direction and removes information from the virtual map that is outside of the range of depth-gradation values of the occlusion target area. In this way, the information-processing system reduces the amount of information in the virtual map while minimizing the effect of the reduction of resolution due to the reduction of the amount of information. In Modification 2, the information-processing system additionally focuses on the image-coordinate-axis (u, v) direction and extracts the range of only the occlusion target area from the virtual map. Then, the information-processing system transmits information of the extracted range of the virtual map from the second information-processing device 102 to the first information-processing device 101.

Note that the block diagram of the entire information-processing system according to Modification 2 is shown in FIG. 1, and the overall processing flowchart according to Modification 2 is the same as the flowchart in FIG. 2. For this reason, the description thereof will be omitted.

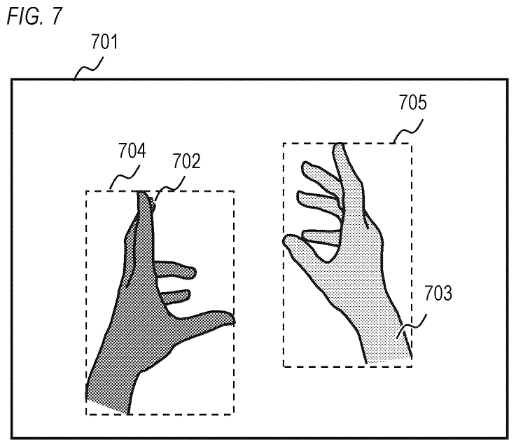

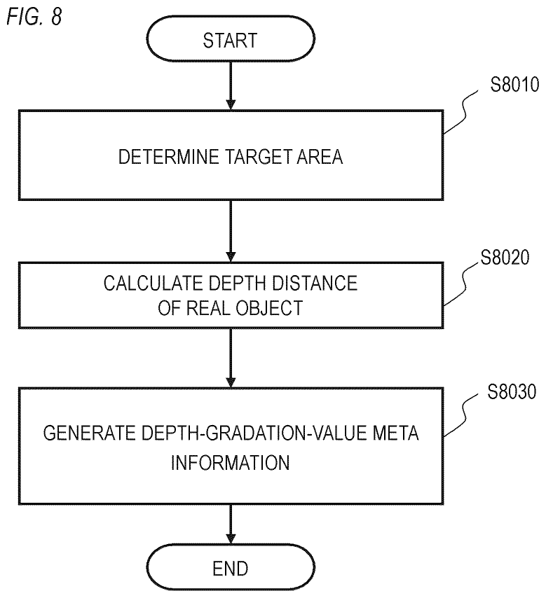

FIG. 7 is a schematic diagram illustrating two occluded real objects 702 and 703 in a depth-gradation-value map 701 estimated by the depth-distance-estimation unit 106. The process of step S2010 in the flowchart of FIG. 2 will be described with reference to the flowchart shown in FIG. 8.

In step S8010, the depth-distance-estimation unit 106 determines the target real object, and then determines the target image area (hereinafter referred to as the “depth-gradation-value transmission area”) to which the depth-gradation value is to be transmitted. The method of determining the target real object is the same as the method described in the first embodiment and Modification 1, so the description will be omitted. For example, the depth-distance-estimation unit 106 separates the real object into a real object 702 and a real object 703 by performing a labeling process on the depth-gradation-value map 701 of the real object. Then, the depth-distance-estimation unit 106 determines a rectangular area 704 that encloses the real object 702 and a rectangular area 705 that encloses the real object 703. The depth-distance-estimation unit 106 determines the rectangular areas 704 and 705 as the depth-gradation-value transmission area. In Modification 2, each element of the depth-gradation-value transmission area is defined as a rectangle, but it may be defined as a polygon, an ellipse, or another shape.

In step S8020, the depth-distance-estimation unit 106 calculates the depth distance of each real object determined in step S8010. The process of step S8020 can be implemented by the same process as the processes of steps S3020 and S6020. The process of steps S8010 and S8020 may be reversed, and the target area may be extracted from the shape of the three-dimensionally reconstructed real object and the depth-gradation-value information.

In step S8030, the meta-information-generation unit 107 generates depth-gradation-value meta information. In Modification 2, the depth-gradation-value meta information includes information on the position and size of each of the rectangular areas 704 and 705. The depth-gradation-value meta information also includes “near value, far value, number of pixels in the range corresponding to the rectangular area 704 after the reduction of the amount of information (number of pixels in the range corresponding to each rectangular area in the simplified map), depth-gradation-value-expression format, and depth-gradation-value-expression bit count” corresponding to the rectangular area 704. The depth-gradation-value meta information includes “near value, far value, number of pixels in the range corresponding to the rectangular area 705 after the reduction of the amount of information, depth-gradation-value-expression format, and depth-gradation-value-expression bit count” corresponding to the rectangular area 705. The depth-gradation-value meta information may also include information on the type of depth-distance-depth-gradation-value-conversion formula for each of the rectangular areas 704 and 705, as necessary.

In Modification 2, when an occlusion area is defined by a plurality of rectangles, the meta-information-generation unit 107 specifies the position and size of the rectangles by the coordinates of the diagonal vertices (for example, the lower left and upper right) on the depth-gradation-value map. However, the method is not limited to this.

Next, the meta-information-generation unit 107 calculates the near value and the far value of the real object corresponding to each of the rectangular areas 704 and 705 constituting the depth-gradation-value transmission area.

Note that in Modification 2, the size of the depth-gradation-value transmission area changes for each frame, so that the communication volume also fluctuates. Therefore, a temporary increase in the communication volume is likely to cause communication instability. Therefore, a threshold Th for the amount of information of the simplified map is set in advance so that the total amount of information of the simplified map does not exceed a certain value. When the meta-information-generation unit 107 determines that the total amount of information of the simplified map exceeds the threshold Th, the resolution of the simplified map may be reduced. Therefore, for example, when the meta-information-generation unit 107 determines that the sum of the information amount of the simplified map exceeds the threshold Th, it controls the number of pixels in the range corresponding to each rectangular area in the simplified map so that the sum of the information amount of the simplified map is equal to the threshold Th.

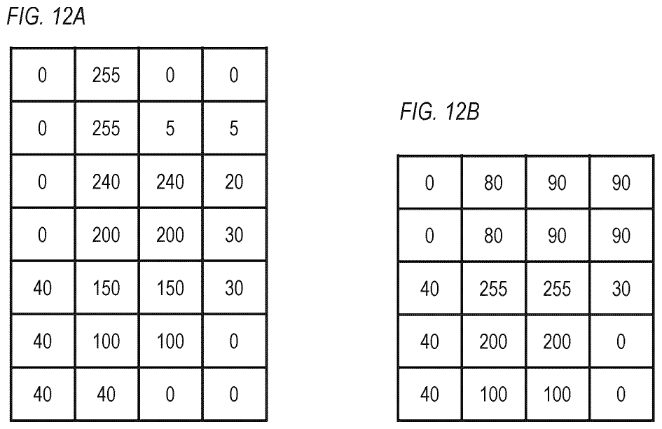

On the basis of the depth-gradation-value meta information generated as described above, the depth-gradation-value-information-reduction unit 114 performs reduction of the depth-gradation value, trimming outside of the depth-gradation-value transmission area, down-conversion, and the like on the virtual map. Specifically, the depth-gradation-value-information-reduction unit 114 generates a simplified map as shown in FIG. 12A and FIG. 12B by extracting the range corresponding to each rectangular area from the virtual map. By doing so, the depth-gradation-value-information-reduction unit 114 further reduces the information amount of the depth-gradation-value map to be transmitted to the first information-processing device 101.

### Modification 3

In the first embodiment, Modification 1, and Modification 2, the overall block of the information-processing system has been described with reference to FIG. 2. On the other hand, the arrangement of the blocks constituting the first information-processing device and the second information-processing device is not necessarily limited to this.

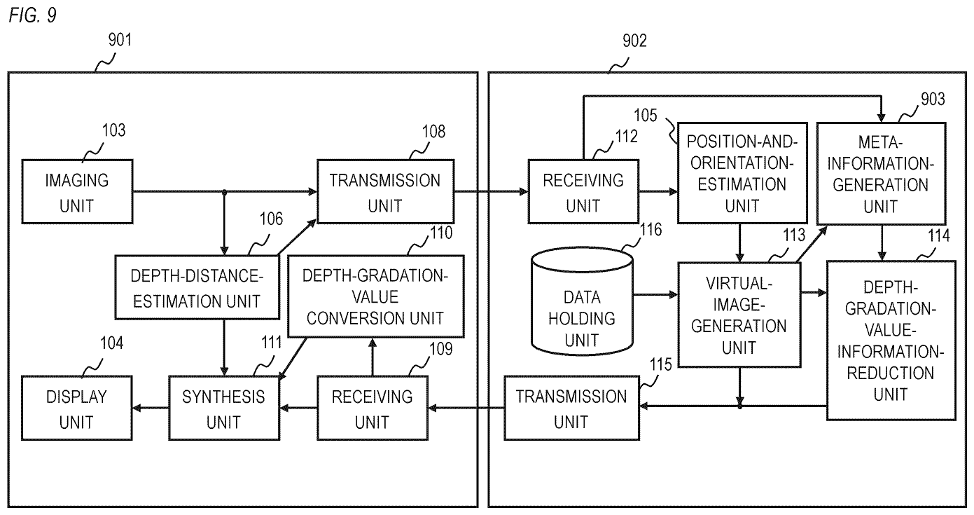

For example, as shown in FIG. 9, the position-and-orientation-estimation unit 105 and the meta-information-generation unit 903 may be disposed in the second information-processing device 902. In this case, the “real map estimated by the depth-distance-estimation unit 106 of the first information-processing device 901” and the “image of the real space (captured image)” may be transmitted to the second information-processing device 102 via the transmission unit 108. The second information-processing device 102 may estimate the position and orientation of the imaging unit 103 and generate depth-gradation-value meta information using these pieces of information.

Furthermore, the meta-information-generation unit 903 may not directly use the real map (real depth-gradation-value information) to generate the depth-gradation-value meta information. For example, when the number of virtual objects to be occluded is limited and it is possible to specify them in advance, the depth-gradation-value meta information may be generated in the same manner as described above based on the depth-gradation-value map (virtual map) of the virtual object. Specifically, the meta-information-generation unit 903 may calculate the maximum and minimum values of the depth distance of a specific virtual object and generate depth-gradation-value meta information so as to include the information. In this case, the depth-gradation-value-information-reduction unit 114 generates a simplified map from the virtual map based on the generated depth-gradation-value meta information.

Note that when there are multiple candidates for virtual objects to be occluded, even if the depth-gradation-value information is reduced using depth-gradation-value meta information that includes information on the “maximum and minimum values of the depth distance” and the “range of the image area” of all the objects, the effect of reducing the amount of information is low. In this case, the virtual object to be occluded may be dynamically selected (changed) on the basis of the operation state of the virtual object by the user or the movement state of the virtual object. For example, when the user selects or moves a virtual object from among multiple virtual objects, only the selected or moved virtual object may be the target of occlusion. Furthermore, if the second information-processing device 102 has three-dimensional information of real objects (for example, hand position or feature-point information in three-dimensional space), virtual objects that are within a certain distance from these real objects may be subject to occlusion.

The generated depth-gradation-value meta information is transmitted to the first information-processing device 901 together with the virtual image and the simplified map. The depth-gradation-value-conversion unit 110 converts the depth-gradation value of the simplified map or the depth-gradation value of the real map based on the depth-gradation-value meta information.

In addition, at least a part of the information in the depth-gradation-value meta information may be predetermined information (a predetermined setting value). For example, the near value and the far value in the depth-gradation-value meta information may be the minimum value and the maximum value of the depth distance in a predetermined depth-distance range.

### Modification 4

In general, the time required for wireless communication (latency) is often longer than that required for wired communication. Furthermore, in the case where processing such as compressing and expanding communication data by a general method is involved in a limited bandwidth, the processing time is added to the latency. In the first embodiment and Modifications 1 and 2, the first information-processing device 101 generates depth-gradation-value meta information and transmits the depth-gradation-value meta information to the second information-processing device 102. The second information-processing device 102 generates a simplified map in which the depth-gradation-value information of the virtual object is compressed on the basis of the depth-gradation-value meta information. Then, the second information-processing device 102 transmits this simplified map together with the color information of the virtual object to the first information-processing device 101. Here, the first information-processing device 101 performs synthesis based on the simplified map. In other words, the total round-trip communication time between the first information-processing device 101 and the second information-processing device 102, as well as the processing time for each operation, are required. Therefore, if a real object to be occluded is moving and real images at different times are used for generating the depth-gradation-value meta information and for synthesis, the delay may cause the real object to deviate from the range of the real object described in the depth-gradation-value meta information during synthesis. As a result, occlusion may not be performed properly.

In Modification 4, when generating a simplified map based on the depth-gradation-value meta information, the second information-processing device 102 estimates the range of existence of the real object at the acquisition time of the real image used for synthesis. This addresses the above-mentioned problem regarding the delay. The basic form of Modification 4 is the same as that described in the first embodiment, Modification 1, and Modification 2, so only the differences will be described below. Note that the following description will be given on the assumption that the acquisition times (imaging times) of the real image used for generating the depth-gradation-value meta information and the real image used for synthesis with the virtual image are different. In addition, the depth-gradation-value map used for synthesis is estimated (generated) on the basis of the real image used for synthesis with the virtual image.

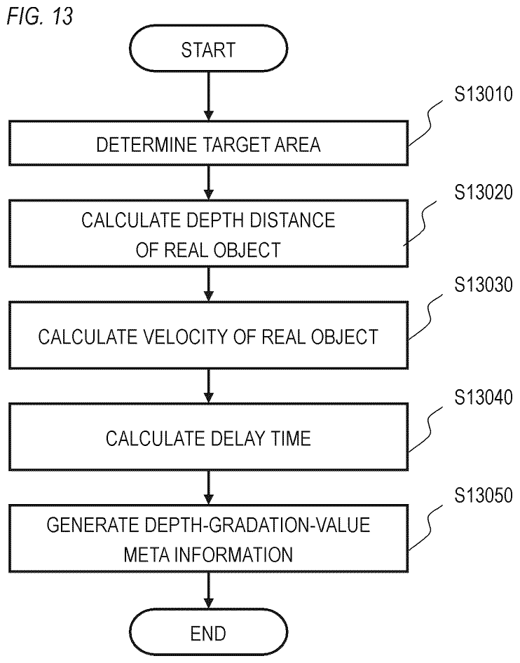

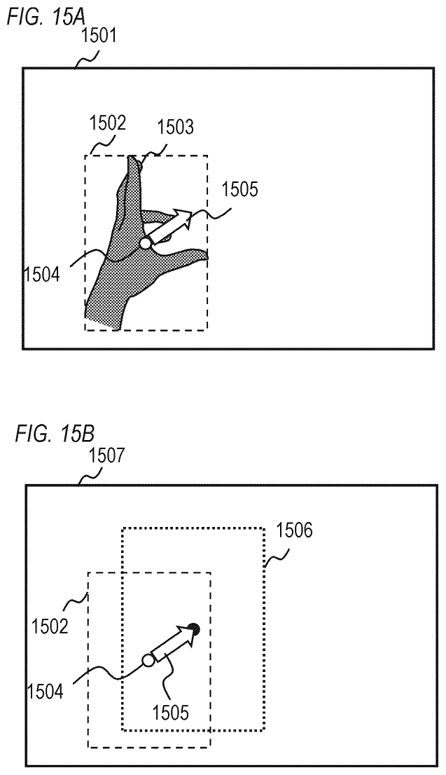

First, the meta-information-generation unit 107 of the first information-processing device 101 calculates “clue information for estimating the existence range of a real object at the time of synthesis by the second information-processing device 102” and adds the clue information to the depth-gradation-value meta information. Then, the process performed in step S2010 of FIG. 2 will be described with reference to the flowchart of FIG. 13. The details of the process will be described with reference to the schematic diagram of FIG. 15A.

Steps S13010 and S13020 are the same as steps S3010 and S3020 of the flowchart of FIG. 3 according to the first embodiment, so their descriptions will be omitted.

In step S13030, the meta information generation unit 107 calculates (detects) the velocity of the real object. In FIG. 15A, the velocity 1505 of the real object 1503 is calculated. The calculated velocity components may differ depending on the base embodiment. For example, in the first embodiment and Modification 1, the existence range of the real object is determined by the near value and the far value, so the depth-direction component of the velocity is necessary. In this case, the velocities of the foremost and the farthest parts of the real object may be calculated on the basis of the “elapsed time from the previous frame to the current frame” and the “changes in the near value and the far value”. Only one representative value of the velocity of the real object may be calculated on the basis of the average of the near value and the far value. In Modification 1, the velocity is calculated for each real object.

In Modification 2, the existence range 1502 of the real object 1503 shown in FIG. 15A is determined by the UV components (components in the planar direction perpendicular to the depth direction) in addition to the depth-direction components. Therefore, the velocity of the UV components is also necessary. In this case, the meta-information-generation unit 107 may obtain the velocities of the diagonal points of the rectangle indicating the existence range 1502 of the real object, or the meta-information-generation unit 107 may obtain the velocity 1505 of the center 1504 or the center of gravity of the existence range 1502 as a representative value of the velocity. In addition, if noise is added to the velocity, the accuracy of the prediction of the existence range decreases. For this reason, the velocity may be obtained by smoothing using a moving average or the like using values calculated in the past.

In step S13040, the meta-information-generation unit 107 calculates the delay time of the depth-gradation-value meta information with respect to the synthesis. The depth-gradation-value meta information is generated on the basis of the real image (the real image used to estimate the depth distance of the real object) acquired by the imaging unit 103. Therefore, the acquisition time of the real image used to estimate the depth distance of the real object is the time T1 corresponding to the depth-gradation-value meta information. On the other hand, in the synthesis, since the depth distance of the latest real object is estimated by the depth-distance-estimation unit 106, the acquisition time of the real image used for the depth-distance estimation (=the real image used for synthesis) is set to time T2. Then, the delay time of the depth-gradation-value meta information for synthesis can be calculated as T2−T1 (the difference between time T2 and time T1). The calculated delay time is used to predict the existence range of the real object in the second information-processing device 102, assuming that it does not fluctuate rapidly in a short time. In addition, if noise-like fluctuations are added to the delay time, the existence range is not predicted correctly. For this reason, the delay time may be calculated by performing smoothing using a moving average using values calculated in the past.

In step S13050, the meta-information-generation unit 107 generates depth-gradation-value meta information. At this time, the meta-information-generation unit 107 generates depth-gradation-value meta information so as to include information on the velocity of the real object and information on the delay time (the delay time of the depth-gradation-value meta information) in addition to each piece of information described in the first embodiment or each modification.

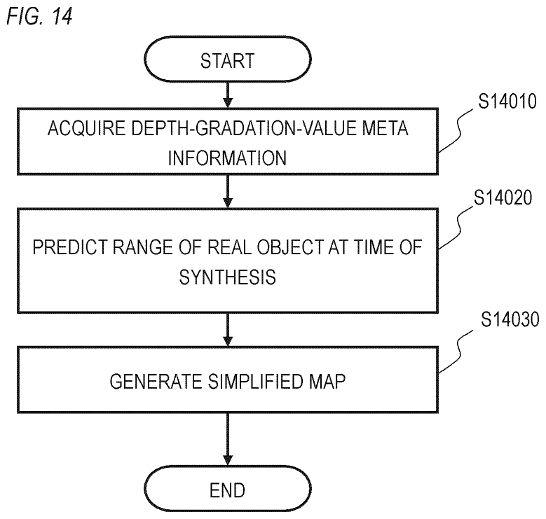

The process performed by the second information-processing device 102 will be described with reference to the flowchart of FIG. 14 and the schematic diagram of FIG. 15B. The flowchart of FIG. 14 shows the process executed instead of step S2030 of the flowchart of FIG. 2. In the second information-processing device 102, the depth-gradation-value-information-reduction unit 114 predicts the existence range of the real object at the time of synthesis based on the depth-gradation-value meta information generated in steps S13010 to S13050. Then, the depth-gradation-value-information-reduction unit 114 generates a simplified map based on the predicted existence range.

In step S14010, the receiving unit 112 acquires (receives) the depth-gradation-value meta information.

In step S14020, the depth-gradation-value-information-reduction unit 114 predicts the range of the real object at the time of synthesis based on information included in the depth-gradation-value meta information (information on the range of the real object, and information on the velocity and delay time). Specifically, the range of the real object at the time of synthesis is predicted by moving the range of the latest real object by a distance calculated from the product of the velocity and the delay time (linear extrapolation by adding the product of the velocity and the delay time to the range of the latest real object).

For example, the “near value, far value” or “depth-distance-representative value” of the real object at the time of synthesis is predicted on the basis of the velocity in the depth direction. When the depth-distance-representative value is predicted, the depth-gradation-value-information-reduction unit 114 predicts the “near value, far value” at the time of synthesis by adding the change amount of the predicted depth-distance-representative value to the “near value, far value”. In the configuration such as Modification 2, the velocity corresponding to the two vertices that are diagonal corners of the rectangle on the UV coordinates or the center (or center of gravity) is obtained in the range of the real object, so that the range of the real object at the time of synthesis can be predicted in a similar manner.

Note that, since the prediction is based on linear extrapolation in the above, an error occurs in the prediction when the velocity of the real object changes. To reduce the influence of this error, the depth-gradation-value-information-reduction unit 114 may set the range of the predicted real object to be larger by a certain margin. In addition, although the prediction is performed linearly in the above, prediction using machine learning may be performed. When a motion sensor, such as an IMU, is attached to the target real object and information on angular velocity or acceleration is obtained, the range of the latest real object may be updated or predicted using these values.

In step S14030, the depth-gradation-value-information-reduction unit 114 generates a simplified map in the same manner as in the first embodiment based on the predicted range of the real object obtained in step S14020.

According to Modification 4, the range of the real object at the time of acquisition of the real image used for synthesis is predicted, and a simplified map is generated on the basis of the prediction result. The real image and the virtual image are then synthesized on the basis of the “real map generated on the basis of the real image used for synthesis” and the “simplified map”. As a result, even if a real object moves, a simplified map is generated that takes the movement into consideration, so that the occlusion of the real object can be implemented appropriately.

### Modification 5

In Modification 2, the second information-processing device 102 generates a simplified map having depth-gradation-value information only for an area where a real object that is subject to occlusion, such as a hand, exists. In Modification 3, the second information-processing device 102 generates a simplified map having depth-gradation-value information for an area where a virtual object that is subject to occlusion exists. In this method, when objects that are subject to occlusion are scattered within the screen, the compression effect of the depth-gradation-value information is reduced. On the other hand, in Modification 5, the area is divided into “an area corresponding to an important object that requires more accurate occlusion” (hereinafter referred to as “important area”) and “an area (range) other than the important area”. Then, the second information-processing device 102 generates a simplified map by compressing the depth-gradation-value information for the area other than the important area. This reduces the data size of the simplified map (depth-gradation-value information) transmitted from the second information-processing device 102 to the first information-processing device 101. This process can also be applied to the configuration of Modification 4.

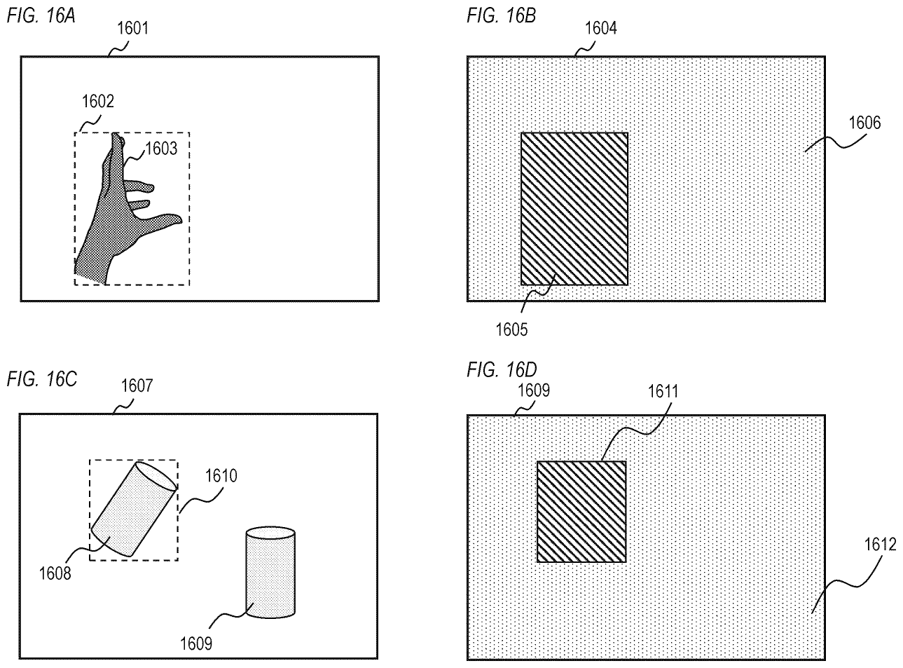

FIG. 16A shows a real image 1601 displayed in the configurations of Modifications 2 and 4. A rectangular area 1602 encompasses a real object 1603. FIG. 16B is a diagram showing a schematic representation of the magnitude relationship of the amount of information of the simplified map corresponding to the real image 1601. For example, the hand area is considered important, and the depth-gradation-value-information-reduction unit 114 increases the amount of information of the depth-gradation value per unit area in a rectangular area 1605 (rectangular range) corresponding to an important area encompassing the hand area. The depth-gradation-value-information-reduction unit 114 reduces the amount of information of the depth-gradation value per unit area in an area 1606 (range) other than the rectangular area 1605, compared to the rectangular area 1605. Thus, it is possible to suppress the amount of information in the entire simplified map.

Similarly, FIG. 16C shows a superimposed real image 1607 in the configuration of Modifications 3 and 4. A virtual object 1608 is an important virtual object designated as important by a predetermined setting or a user's instruction. FIG. 16D is a diagram showing a schematic diagram of the magnitude relationship of the amount of information in the simplified map corresponding to the real image 1607. In an area 1611 corresponding to a rectangular area 1610 that includes an important virtual object, the amount of information of the depth-gradation value per unit area is large. The amount of information of the depth-gradation value per unit area of the other area 1612 (area 1612 corresponding to an area including the virtual object 1609) is small compared to the area 1611.

The above-mentioned area with a small amount of information is implemented by relatively reducing the number of bits representing the depth-gradation value or reducing the resolution. By including the setting of the method for reducing the amount of information in the depth-gradation-value meta information, it is possible to achieve consistency between the reduction of the depth-gradation-value information in the second information-processing device 102 and the depth-gradation-value conversion in the first information-processing device 101. In other words, appropriate occlusion can be implemented.

In the following, information included in the depth-gradation-value meta information will be described. When the number of bits representing the depth-gradation value is relatively small, the depth-gradation value meta information includes “a part or all of the depth-gradation-value-expression bit count representing the depth-gradation value and the depth-gradation-value-expression format, the near value, the far value, and the format of the depth-distance-depth-gradation-value-conversion formula” other than the important area in addition to the information of the important area. The near value and the far value may be fixed values or may be determined from the upper and lower limit values of the depth-gradation value in the real space. When the resolution of the depth-gradation-value map is relatively reduced, the depth-gradation-value meta information includes the number of pixels in width and height indicating the size of the important area, and the number of pixels in width and height of the map indicating the depth-gradation value other than the important area. Note that a process of relatively reducing the resolution and the number of bits may be performed together.

If a simplified map with a reduced information amount is directly converted and used for occlusion, jaggies may occur at the boundary between the occlusion of the real object and the virtual object. For this reason, in order to make the simplified map and the real map comparable, the depth-gradation-value-conversion unit 110 of the first information-processing device 101 may convert the simplified map to the same amount of information (depth-gradation-value-expression bit count or resolution) as the real map, and then perform a smoothing process.

In addition, to prevent the amount of information of the simplified map from fluctuating greatly depending on the presence or absence of an important area, if no important area exists in the real image (screen), a rectangular area (rectangular range) corresponding to the center of the real image may be set as the important area. The amount of information of the depth-gradation value per unit area may be less in the area other than the center than in the area corresponding to the center.

In addition, in the above, the expression “in a case where A is no less than B, the flow advances to step S1, and in a case where A is smaller than (lower than) B, the flow advances to step S2” may be interpreted as “in a case where A is greater (higher) than B, the flow advances to step S1, and in a case where A is not more than B, the flow advances to step S2”. Conversely, “in a case where A is greater (higher) than B, the flow advances to step S1, and in a case where A is not more than B, the flow advances to step S2” may be interpreted as “in a case where A is no less than B, the flow advances to step S1, and in a case where A is smaller than (lower than) B, the flow advances to step S2”. Accordingly, provided there is no resulting contradiction, the phrase “no less than A” may be substituted with “A or greater (higher, longer, more) than A” and may be interpreted as “greater (higher, longer, more) than A”. Conversely, the phrase “not more than A” may be substituted with “A or smaller (lower, shorter, less) than A” and may be interpreted as “smaller (lower, shorter, less) than A”. Furthermore, “greater (higher, longer, more) than A” may be interpreted as “no less than A”, and “smaller (lower, shorter, less) than A” may be interpreted as “not more than A”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiments described above (including variation examples) are examples. Any configurations obtained by suitably modifying or changing some configurations of the embodiment within the scope of the subject matter of the present disclosure are also included in some embodiments of the present disclosure. Some embodiments of the present disclosure also include other configurations obtained by suitably combining various features of the embodiment.

According to the present disclosure, when implementing occlusion of one object by another object in MR or AR, it is possible to suppress a shortage of communication bandwidth.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-082195, which was filed on May 20, 2024, and Japanese Patent Application No. 2024-144262, which was filed on Aug. 26, 2024, both of which are hereby incorporated by reference herein in their entireties.

What is claimed is:

1. An information-processing device that is a first device, the information-processing device comprising:
one or more processors configured to:
perform a first acquisition process to acquire a first image;
perform a first map-acquisition process to acquire a first depth-gradation-value map indicating depth-gradation-value information corresponding to the first image;
perform a reduction process to generate a second depth-gradation-value map by reducing an amount of information of the first depth-gradation-value map based on meta information so as to represent a range of depth distance corresponding to the meta information; and
perform a first transmission process to transmit the first image and the second depth-gradation-value map to a second device.

2. The information-processing device according to claim 1, wherein
the meta information includes information on a minimum value and a maximum value of a depth distance of a first object, and
in the reduction process, the second depth-gradation-value map is generated by reducing an amount of information of the first depth-gradation-value map so as to represent the range of depth distance between the minimum value and the maximum value of the depth distance of the first object.

3. The information-processing device according to claim 2, wherein the meta information includes information on a depth-gradation-value-expression format for each pixel of the second depth-gradation-value map and information on a number of representation bits of the second depth-gradation-value map.

4. The information-processing device according to claim 3, wherein the information on the number of representation bits in the meta information changes depending on a communication status between the first device and the second device.

5. The information-processing device according to claim 2, wherein the meta information includes information on a relational expression for converting a depth distance into a depth-gradation value.

6. The information-processing device according to claim 2, wherein, in the reduction process, if a communication status between the first device and the second device is a specific communication status, processing of reducing the amount of information of the first depth-gradation-value map is not performed.

7. The information-processing device according to claim 2, wherein the meta information includes information on an image area of the first object.

8. The information-processing device according to claim 7, wherein the meta information includes information on a number of pixels in a range corresponding to the image area of the second depth-gradation-value map.

9. The information-processing device according to claim 8, wherein the information on the number of pixels in the range corresponding to the image area in the meta information changes depending on a communication status between the first device and the second device.

10. The information-processing device according to claim 7, wherein the reduction process reduces the amount of information in the first depth-gradation-value map so as to express the range of depth distance corresponding to the meta information, and generates the second depth-gradation-value map by extracting a range of the first depth-gradation-value map corresponding to the image area based on the meta information.

11. The information-processing device according to claim 7, wherein the meta information includes information on each of a first area that is the image area and a second area that is not the image area.

12. The information-processing device according to claim 1, wherein the meta information includes information on each of a first area that corresponds to a central part of an image and a second area that corresponds to a part other than the central part.

13. The information-processing device according to claim 11, wherein, in the reduction process, the second depth-gradation-value map is generated by reducing the amount of information of the first depth-gradation-value map so that amount of information of the depth-gradation value per unit area in the range corresponding to the second area is less than amount of information of the depth-gradation value per unit area in the range corresponding to the first area.

14. The information-processing device according to claim 1, wherein at least a part of the information in the meta information is predetermined information.

15. The information-processing device according to claim 2, wherein the one or more processors further execute a generation process to generate the meta information based on the first depth-gradation-value map,
wherein the first image includes the first object, and
wherein in the first transmission process, the meta information, the first image, and the second depth-gradation-value map are transmitted to the second device.

16. The information-processing device according to claim 15, wherein the first object is specified in response to a user operation or a movement of an object.

17. An information-processing system comprising:
a first device; and
a second device,
wherein the first device comprises:
one or more processors configured to:
perform a first acquisition process to acquire a first image;
perform a first map-acquisition process to acquire a first depth-gradation-value map indicating depth-gradation-value information corresponding to the first image;
perform a reduction process to generate a second depth-gradation-value map by reducing an amount of information of the first depth-gradation-value map based on meta information so as to represent a range of depth distance corresponding to the meta information; and
perform a first transmission process to transmit the first image and the second depth-gradation-value map to a second device, and
wherein the second device comprises:
one or more processors configured to perform:
a second acquisition process of acquiring a second image;
a second map-acquisition process of acquiring a third depth-gradation-value map indicating depth-gradation-value information corresponding to the second image,
a generation process of generating the meta information based on the third depth-gradation-value map, and
a second transmission process of transmitting the meta information to the first device.

18. The information-processing system according to claim 17, wherein
the second image includes a first object and a second object,
the meta information includes information on a minimum value and a maximum value of a depth distance of the first object and information on a minimum value and a maximum value of a depth distance of the second object, and
in the reduction process, the second depth-gradation-value map is generated by reducing an amount of information of the first depth-gradation-value map so as to represent a range of depth distance between the minimum and the maximum value of the depth distance of the first object and a range of depth distance between the minimum and the maximum value of the depth distance of the second object.

19. A control method of an information-processing device that is a first device, the control method comprising:
acquiring a first image;
acquiring a first depth-gradation-value map indicating depth-gradation-value information corresponding to the first image;
generating a second depth-gradation-value map by reducing an amount of information of the first depth-gradation-value map based on meta information so as to represent a range of depth distance corresponding to the meta information; and
transmitting the first image and the second depth-gradation-value map to a second device.

20. A non-transitory computer-readable medium that stores computer-executable instructions that, when executed by a computer, cause the computer to execute a control method of an information-processing device that is a first device, the control method comprising:
acquiring a first image;
acquiring a first depth-gradation-value map indicating depth-gradation-value information corresponding to the first image;
generating a second depth-gradation-value map by reducing an amount of information of the first depth-gradation-value map based on meta information so as to represent a range of depth distance corresponding to the meta information; and
transmitting the first image and the second depth-gradation-value map to a second device.
